(19) United States
(12) Patent Application Publication
(10) Pub. No.: US 2021/0402482 A1
(43) Pub. Date: Dec. 30, 2021

(54) CONTROLLING COLD SPRAY DEPOSITION ADHESION FOR INDUCED SUBSTRATE RELEASE

(71) Applicant: U.S. Army DEVCOM, Army Research Laboratory, Adelphi, MD (US)

(72) Inventors: Gehn D. Ferguson, Baltimore, MD (US); Kenneth W. Young, Bear, DE (US); Isaac M. Nault, Baltimore, MD (US); Brian Sparber, Media, PA (US); Aaron T. Nardi, East Granby, CT (US)

(21) Appl. No.: 17/344,204

(22) Filed: Jun. 10, 2021

Related U.S. Application Data
(60) Provisional application No. 63/043,809, filed on Jun. 25, 2020.
(60) Provisional application No. 63/043,973, filed on Jun. 25, 2020.

(51) Int. Cl. B22F 12/88; B33Y 10/00; B33Y 40/00; B33Y 30/00; B22F 10/25; B22F 12/30; C23C 24/04

(52) U.S. Cl. CPC B22F 12/88; B33Y 10/00; B33Y 40/00; C23C 24/04; B22F 10/25; B22F 12/30; B33Y 30/00

(57) ABSTRACT

A system and method for controlling cold spray deposit adhesion for induced release of a deposit from a substrate includes tuning a material surface condition of a substrate used to support a build of a cold spray material to a level proportionate with deposition conditions of the cold spray material for adhesion to the substrate; selecting an impact velocity for deposition of the cold spray material to be substantially equal to or greater than a critical velocity for adhesion of the cold spray material to the substrate; depositing the cold spray material on the substrate to form a deposit; and releasing the deposit from the substrate without permanently damaging the substrate to allow for reuse of the substrate for a subsequent cold spray deposition process.

### CROSS-REFERENCE TO RELATED APPLICATION(S)

This application claims the benefit of U.S. Provisional Patent Application No. 63/043,809 filed on Jun. 25, 2020 and U.S. Provisional Patent Application No. 63/043,973 filed on Jun. 25, 2020, which are incorporated herein by reference in their entireties.

### GOVERNMENT INTEREST

The embodiments herein may be manufactured, used, and/or licensed by or for the United States Government without the payment of royalties thereon.

### BACKGROUND

### Technical Field

The embodiments herein generally relate to mold release technology, and more particularly to mold release in cold spray deposition processes for additive manufacturing applications.

### Description of the Related Art

Conventionally, rotor blade erosion caps are made by electroformed nickel plating. This is a process that generally results in a uniform thickness deposit. Deposition rates can be increased locally, forming non-uniform thickness, but the final thickness is difficult to precisely control, and the preferential deposition rates are known to cause material defects. Electroformed nickel is also susceptible to material property variations based upon plating bath chemistries, which can be detrimental to component performance. Cold spray offers a line of sight technique that can yield improved material performance, and near net shape capabilities to minimize post machining through utilization of advanced robotic path planning. However, the state of the art for cold spray additive manufacturing utilizes sacrificial tooling, which increases overall manufacturing costs. One commonly utilized technique is to cold spray onto a sacrificial mold, such as aluminum, that can later be dissolved away in a NaOH or HCl bath leaving behind just the cold spray material. Alternatively, if the geometry of the cold spray part allows, the deposit can be cut away from the substrate using traditional machining or wire electrical discharge machining (EDM) processes. Enabling controlled and induced release of cold spray deposits will enable tool re-use and reduce production costs and increase manufacturing throughput. Other techniques utilize sacrificial molds that can be molted or dissolved away or are removed via traditional methods such as wire EDM.

In some other conventional mold release methods, a zinc interlayer is provided between the substrate and the cold spray. The zinc is molten away to allow for removal of the cold spray deposit. Another conventional technique involves an additively manufactured aluminum mold dissolved using either NaOH or HCl. However, these techniques suffer when evaluating for manufacturing process scalability as the tool would either require rework or remanufacture which yields the overall manufacturing process cost prohibitive.

U.S. Pat. No. 8,584,732, the complete disclosure of which, in its entirety is herein incorporated by reference, describes a method for releasing cold spray deposit from a mold. The patented solution offered a technique for the purpose it was intended for at the time of that invention. However, with new and more robust demands on reducing manufacturing costs, there are some limitations associated with the '732 patent. For example, the patented solution relies on coating the mold with a release agent to separate the mold from the cold spray deposit. In this patent, it is required that the release agent be compatible with the mold. There is also no process to tune the properties of the mold material. Accordingly, the challenge with the patent as presented is that it requires reliance on a mold release agent and requires the mold release agent to be compatible with the substrate. Moreover, thermal and chemical processes as described in the patent would not allow for re-use of the mold. Furthermore, there may be restrictions in terms of the type of cold spray materials that can be used in the solution due to compatibility limitations. Therefore, there remains a need for a new cold spray technique, which overcomes some of the challenges and limitations of the conventional solutions.

### SUMMARY

In view of the foregoing, an embodiment herein provides a method of controlling cold spray deposit adhesion for induced release of a deposit from a substrate, the method comprising tuning a material surface condition of a substrate used to support a build of a cold spray material to a level proportionate with deposition conditions of the cold spray material for adhesion to the substrate; selecting an impact velocity for deposition of the cold spray material to be substantially equal to or greater than a critical velocity for adhesion of the cold spray material to the substrate; depositing the cold spray material on the substrate to form a deposit; and releasing the deposit from the substrate without permanently damaging the substrate to allow for reuse of the substrate for a subsequent cold spray deposition process.

The method may comprise increasing the material surface condition of the substrate by carburization of the substrate. The method may comprise increasing the material surface condition of the substrate by nitriding the substrate. The method may comprise increasing the material surface condition of the substrate by heat treatment of the substrate. The method may comprise selecting materials that lend themselves to reduction in bonding adhesion. The method may comprise releasing the deposit from the substrate using thermal shock. The method may comprise releasing the deposit from the substrate using vibration. The method may comprise releasing the deposit from the substrate using a mechanical release mechanism. The impact velocity may be selected to lower an adhesion strength of the cold spray material to the substrate. The method may comprise providing a material release layer on the substrate. The material release layer may comprise a same material as the cold spray material.

Another embodiment provides a system for controlling cold spray deposit adhesion for induced release of a deposit from a substrate, the system comprising a first mechanism to tune a material surface condition of a substrate used to support a build of a cold spray material to a level proportionate with deposition conditions of the cold spray material for adhesion to the substrate; a processor to select an impact velocity for deposition of the cold spray material to be substantially equal to or greater than a critical velocity for adhesion of the cold spray material to the substrate; a cold spray applicator device to deposit the cold spray material on the substrate to form a deposit; and a second mechanism to release the deposit from the substrate without permanently damaging the substrate to allow for reuse of the substrate for a subsequent cold spray deposition process.

The material surface condition of the substrate may be tuned by carburization of the substrate. The material surface condition of the substrate may be tuned by nitriding the substrate. The material surface condition of the substrate may be tuned by heat treatment of the substrate. The second mechanism may release the deposit from the substrate using thermal shock. The second mechanism may release the deposit from the substrate using vibration. The second mechanism may release the deposit from the substrate using a mechanical release mechanism. The processor may select the impact velocity to lower an adhesion strength of the cold spray material to the substrate. The system may comprise a third mechanism to apply a material release layer on the substrate. The material release layer may comprise a same material as the cold spray material.

These and other aspects of the embodiments herein will be better appreciated and understood when considered in conjunction with the following description and the accompanying drawings. It should be understood, however, that the following descriptions, while indicating exemplary embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram illustrating a system for controlling cold spray deposit adhesion for induced release of a deposit from a substrate, according to an embodiment herein;

FIG. 2 is a block diagram illustrating the system of FIG. 1 with a mechanical release mechanism for releasing the deposit from the substrate, according to an embodiment herein;

FIG. 3 is a block diagram illustrating the system of FIG. 1 with a third mechanism for applying a material release layer, according to an embodiment herein;

FIG. 4 is a flow diagram illustrating a method of controlling cold spray deposit adhesion for induced release of a deposit from a substrate, according to an embodiment herein;

FIG. 5 is a graphical representation illustrating the relationship between the hardness and adhesion strength for various materials, according to an embodiment herein;

FIG. 6 is a graphical representation illustrating the relationship between process conditions and particle impact velocity, according to an embodiment herein; and

FIG. 7 is a graphical representation illustrating effect of impact velocity on adhesion strength, according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

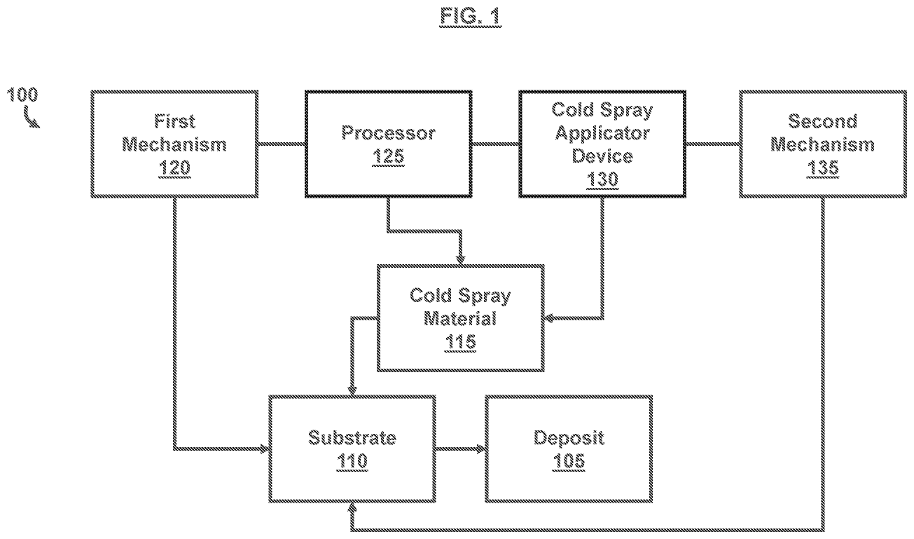

The embodiments herein provide a technique for using cold spray for additive manufacturing in a production relevant manner, and which enables re-usable tooling without the requirement of mold release agents. A combination approach is provided of increasing or otherwise tuning substrate surface conditions and selecting reduced velocity cold spray bond layer conditions enables controlled release of cold spray from substrate molds. The embodiments herein have utility in several manufacturing applications such as the manufacturing of helicopter rotor blade erosion caps, airfoil skins, engine lip skins, missile fin skins, missile nose skins, propeller blade protective strips, and turbine blade protective strips formed by cold spray deposition, among other applications. As mentioned above, conventional mold release techniques have tended to rely on sacrificial molds or mold release layers, which results in significant cost, cross-tool tolerance challenges, and the risk of material property degradation from the introduction of additional materials and release processes. Conversely, the embodiments herein do not require the use of chemical methods to induce release. Referring now to the drawings, and more particularly to FIGS. 1 through 7, where similar reference characters denote corresponding features consistently throughout the figures, there are shown preferred embodiments. In the drawings, the size and relative sizes of components, layers, and regions, etc. may be exaggerated for clarity.

FIG. 1 illustrates a system 100 for controlling cold spray deposit adhesion for induced release of a deposit 105 from a substrate 110. As used herein, the deposit 105 may be any suitable type of material used in cold spray deposition processes. Moreover, the substrate 110 may include any type of mold, mandrel, and/or tooling surface upon or in which the deposit 105 is deposited. For example, the substrate 110 may comprise a metallic, ceramic, stone, glass, plastic, or composite surface. Moreover, other types of materials may be used for the substrate 110. The surface of the substrate 110 may be a negative image of a desired finished part to be constructed through the additive manufacturing process. The system 100 may comprise one or more, or a combination, of electrical, mechanical, electro-mechanical, optical, magnetic, chemical, and software-enabled devices arranged to perform cold spray deposition and mold release. As such, the system 100 described herein provides a cold spray and mold release technique in which adhesion is systematically controlled through a combination of tool material selection, tool material processing to increase hardness, and the use of reduced velocity cold spray bond layers. The adhesion is controlled to a point where the deposit 105 remains adhered to the substrate 110 through the duration of the cold spray build, and then release can be induced in a controlled fashion without damage to the substrate 110.

According to an example, the system 100 comprises a first mechanism 120 to tune a material surface condition, such as hardness, of a substrate 110 used to support a build of a cold spray material 115 to a level proportionate with deposition conditions of the cold spray material 115 for adhesion to the substrate 110. In an example, the cold spray material 115 may comprise metal particles including gold, silver, bronze, copper, nickel, aluminum, chrome, titanium, tin, cermet, and stainless steel, among other materials. Cold spray is a solid-state powder deposition process in which 10-50 micron diameter metal particles are accelerated to speeds of up to 2000 m/s in a heated supersonic gas stream. At such high speeds, the cold spray material 115 bonds with nearly any metallic surface with which they come into contact causing a deposit 105 to form. The cold spray material 115 forms a metallurgical and mechanical bond with the substrate 110 resulting in high adhesion strengths therebetween.

The bond quality is highly correlated with the amount of plastic deformation that occurs in both the particles of the cold spray material 115 and the substrate 110. Therefore, all else the same, harder materials, with more resistance to plastic deformation, have a lower propensity for bonding than softer materials. Further, higher particle velocity impacts lead to higher plastic deformation and thus greater bond strength; i.e., better adhesion. These two physical aspects provide tunable parameters to precisely control the interface adhesion strength between the cold spray material 115 and the substrate 110.

The first mechanism 120 may comprise an electrical, mechanical, electro-mechanical, optical, magnetic, chemical, or software-enabled device, or a combination thereof. Moreover, the first mechanism 120 may tune the material surface condition of the substrate 110 in various ways. For example, the material surface condition of the substrate 110 may be tuned by carburization of the substrate 110, nitriding the substrate 110, carbo-nitriding (a combination of carbon and nitrogen diffusion into the surface of the substrate 110), or by performing heat treatment or surface treatment of the substrate 110. The hardness of the material of the substrate 110 can be tuned to controllably reduce adhesion of the cold spray material 115 to the substrate 110, which facilitates the ability to release the substrate 110 after the cold spray deposition is completed. For example, through heat treatment and surface treatments, the substrate hardness of carburizable and heat treatable steels can be increased, whereby increased hardness of the substrate 110 reduces cold spray adhesion, all else being equal.

The system 100 further includes a processor 125 to select an impact velocity for deposition of the cold spray material 115 to be substantially equal to or greater than a critical velocity for adhesion of the cold spray material 115 to the substrate 110. In an example, the processor 125 may select the impact velocity of the cold spray material 115 to lower an adhesion strength of the cold spray material 115 to the substrate 110. The processor 125 may comprise any of an integrated circuit, an ASIC, FPGA, a microcontroller, a microprocessor, an ASIC processor, a digital signal processor, a networking processor, a multi-core processor, or other suitable processors. In some examples, the processor 125 may comprise a CPU of a computer or other device. In other examples the processor 125 may be a discrete component independent of other processing components in a computer or other device. In other examples, the processor 125 may be a microcontroller, hardware engine, hardware pipeline, and/or other hardware-enabled device suitable for receiving, processing, operating, and performing various functions required by a computer or other device.

The processing techniques performed by the processor 125 may be implemented as one or more software modules in a set of logic instructions stored in a machine or computer-readable storage medium such as RAM, ROM, PROM, firmware, flash memory, etc. in configurable logic such as, for example, PLAs, FPGAs, CPLDs, in fixed-functionality hardware logic using circuit technology such as, for example, ASIC, CMOS, or TTL technology, or any combination thereof. For example, computer program code to carry out processing operations performed by the processor 125 may be written in any combination of one or more programming languages.

The system 100 further includes a cold spray applicator device 130 to deposit the cold spray material 115 on the substrate 110 to form a deposit 105. In some examples, the cold spray application device 130 may comprise an automated high-pressure spray mechanism, which may be a portable or stationary. The cold spray applicator device 130 may include various sub-components such as a gas chamber, power supply, heater, gas pressure controller, and gas temperature controller, among other sub-components. The cold spray applicator device 130 may be partially or fully automated, or partially or fully controlled by a user. The cold spray applicator device 130 utilizes a high-speed gas jet to controllably accelerate the cold spray material 115 in the form of powder particles onto the substrate 110 such that the cold spray material 115 plastically deforms and consolidate upon impact on the substrate 110 to form the deposit 105. The deposition of the cold spray material 115 by the cold spray applicator device 130 onto the substrate 110 may be selected based on a pre-programmed or real-time deposition sequence to form the deposit 105 in a selected form, shape, or configuration, etc.

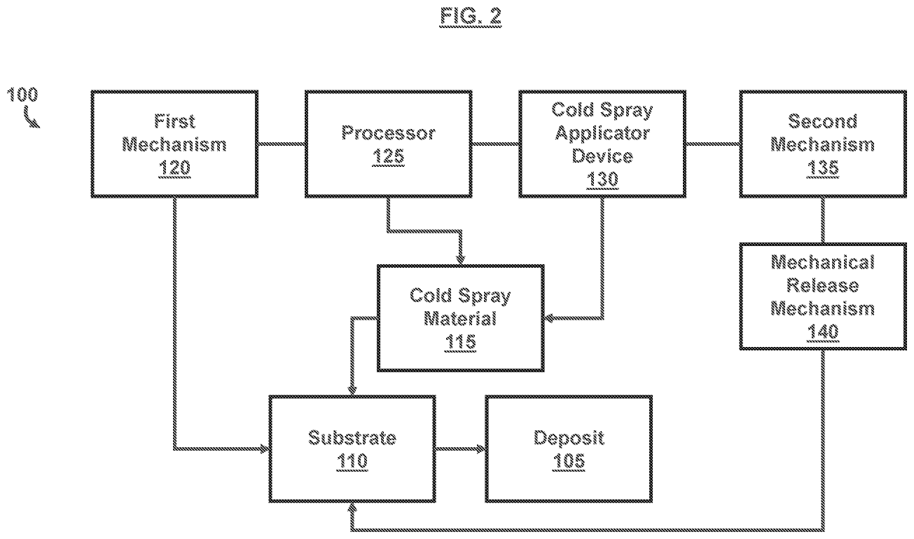

The system further includes a second mechanism 135 to release the deposit 105 from the substrate 110 without permanently damaging the substrate 110 to allow for reuse of the substrate 110 for a subsequent cold spray deposition process. According to the embodiments herein, through the selection of proper tool hardness and reduced velocity bond coat processes, it is possible to reuse the mold tooling and spray a larger range of materials without the same concerns for material compatibility. Moreover, utilizing this technique mitigates the risk of material property degradation through contamination, diffusion, or other interaction between the cold spray material 115 and the substrate 110 since a required mold release agent is avoided. The risk of altering the properties due to machining, cutting, or chemical processing is also avoided as the adhesion can be tuned to allow for release of the deposit at temperature changes at which microstructural changes do readily occur. In some examples, the second mechanism 135 may release the deposit 105 from the substrate 110 using thermal shock, vibration, or by other mechanical techniques, or a combination thereof. Accordingly, through the use of carefully selected cold spray process parameters at which the velocity of the particles of the cold spray material 115 is above the critical velocity for deposition, but below a threshold where significant levels of bonding occur, the adhesion of cold spray deposits can be systematically controlled to enable controlled release of the deposit 105 from the substrate 110 through thermal, vibrational, or mechanical means. As shown in FIG. 2, the second mechanism 135 may release the deposit 105 from the substrate 110 using a mechanical release mechanism 140. In an example, the mechanical release mechanism 140 may include mechanical or robotic tools used to remove the deposit 105 from the substrate 110 without requiring the use of machining, cutting, or chemical processes.

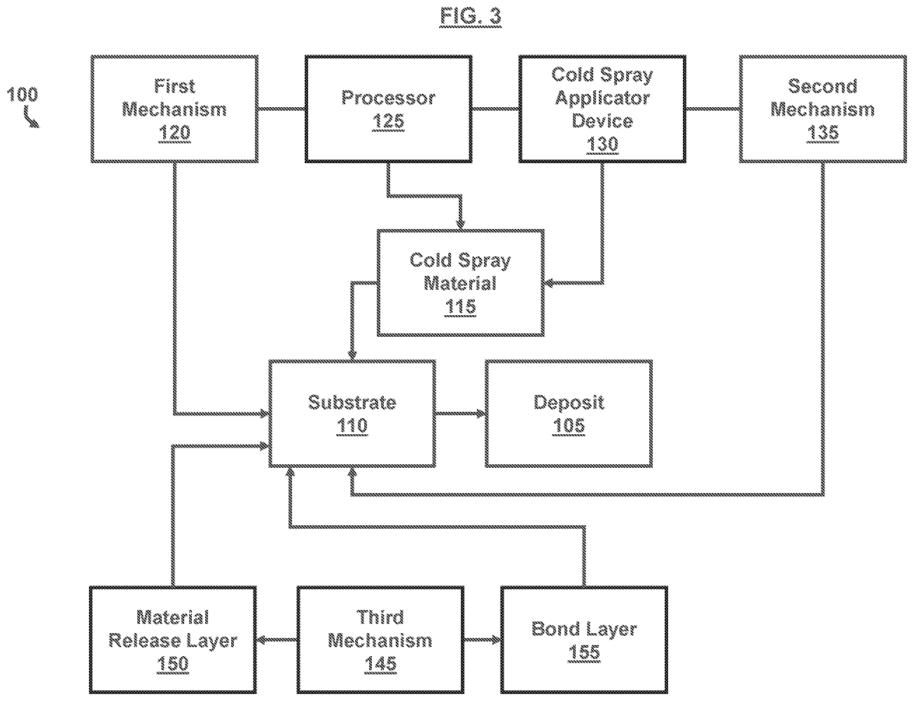

As shown in FIG. 3, the system 100 may comprise a third mechanism 145 to apply an optional material release layer 150 on the substrate 110. Accordingly, the material release layer 150 is not required. In an example, the third mechanism 145 may comprise a nozzle and applicator device that selectively applies the material release layer 150 on the substrate 110 prior to deposition of the cold spray material 115 by the cold spray applicator device 130. The third mechanism 145 may comprise an electrical, mechanical, or an electro-mechanical device, according to various examples. The material release layer 150 may comprise a same material as the cold spray material 115, in an example. Thus, examples of the material release layer 150 may include gold, silver, bronze, copper, nickel, aluminum, chrome, titanium, tin, cermet, and stainless steel, among other materials.

The third mechanism 145 may also be used to apply a cold spray bond layer 155 prior to bulk deposition of the cold spray material 115 through selection of reduced velocity spray conditions known as “Low Velocity Bond Pass” or “Intermediate Velocity Bond Pass” coupled with tool surface hardening techniques, which can provide significant control over deposit adhesion to enable controlled release of the deposit 105 from the substrate 110 for cold spray additive manufacturing. Controlled release of the deposit 105 is critical so that the bond is maintained throughout the entire build process but given controllable inputs, such as the substrate hardness and impact velocity, will consistently release. The substrate 110 may then be reused for further manufacturing, making the process more economical.

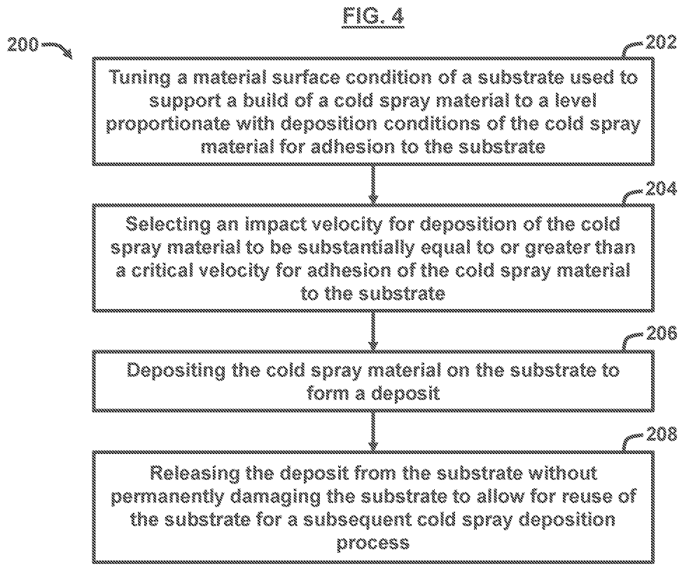

FIG. 4, with reference to FIGS. 1 through 3, is a flow diagram illustrating a method 200 of controlling cold spray deposit adhesion for induced release of a deposit 105 from a substrate 110, the method 200 comprising tuning (202) a material surface condition of a substrate 110 used to support a build of a cold spray material 115 to a level proportionate with deposition conditions of the cold spray material 115 for adhesion to the substrate 110; selecting (204) an impact velocity for deposition of the cold spray material 115 to be substantially equal to or greater than a critical velocity for adhesion of the cold spray material 115 to the substrate 110; depositing (206) the cold spray material 115 on the substrate 110 to form a deposit 105; and releasing (208) the deposit 105 from the substrate 110 without permanently damaging the substrate 110 to allow for reuse of the substrate 110 for a subsequent cold spray deposition process. The method 200 may comprise increasing the material surface condition of the substrate 110 by carburization, nitriding, or carbo-nitriding of the substrate 110. Moreover, the method 200 may comprise increasing the material surface condition of the substrate 110 by heat treatment of the substrate 110. Additionally, the method 200 may comprise releasing the deposit 105 from the substrate 110 using thermal shock, vibration, or using a mechanical release mechanism 140, or a combination thereof. In an example, the impact velocity may be selected to lower an adhesion strength of the cold spray material 115 to the substrate 110. The method 200 may optionally comprise providing a material release layer 150 on the substrate 110. In an example, the material release layer 150 may comprise a same material as the cold spray material 115. According to an example, the method 200 may comprise selecting materials that lend themselves to reduction in bonding adhesion. For example, various materials may be selected including free-machining steels, such as SAE 303 stainless steel, which is a sulfur containing stainless steel alloy. In this regard, sulfur inclusions may reduce transverse ductility, which may result in reduced bonding strength.

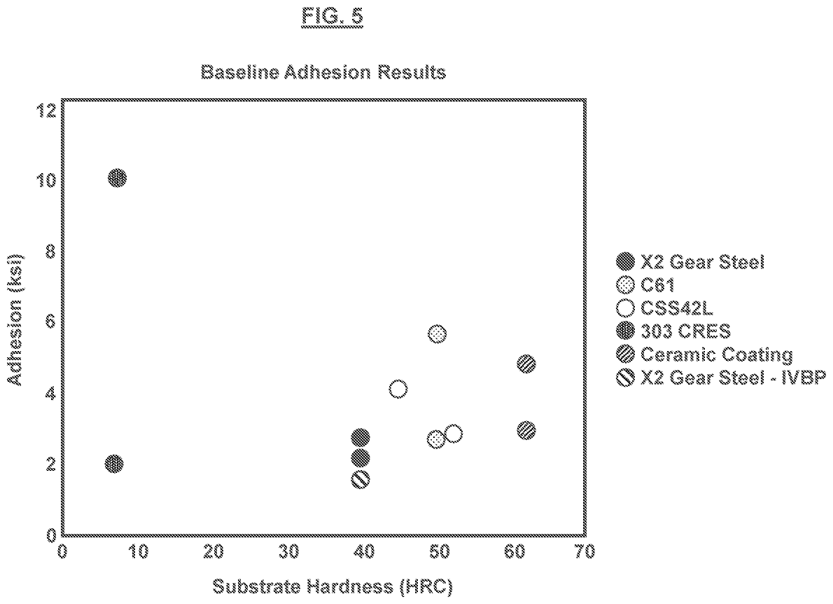

The effect of hardness on adhesion strength for two substrate materials is shown in FIG. 5. The adhesion values shown in this plot were obtained through ASTM C633 testing, which is a standard test method for measuring tensile adhesion strength in which cold spray is applied to one end of a cylindrical bond bar and a glue is used to mate the top surface of the cold spray coating to the other end of the bond fixture. This test will only yield quantitative values of the adhesion when the interfacial adhesion strength of the cold spray to the substrate is less than that of the glue to the cold spray. The strength of the glue is approximately 12 ksi. The targeted adhesion values for controlled release are less than 12 ksi, so this is a good test to use for this application.

FIG. 5 shows that, within a material system, there is a predictable relationship between hardness and adhesion strength, namely increasing hardness results in decreasing adhesion strength. This was experimentally shown for CSS-42L, a carburizable stainless steel, and X2, a gear steel. CSS-42L was tested at three hardness conditions: 45 HRC, 52 HRC obtained through heat treatment, and 58 HRC obtained through carburization. X2 was tested at two hardness conditions: 40 HRC, and 63 HRC obtained through carburization. This plot does not show any evidence that the relationship between hardness and adhesion strength is carried across material systems. This suggests that there are other more complicated factors at play, such as material chemistry, that affect adhesion. However, if there is a mechanism to increase the hardness of a material, the adhesion strength can be selectively lowered.

As mentioned above, the use of particle velocity to control adhesion strength is a parameter that can be controlled. The impact velocity of particles is a function of many variables the most important of which are the nozzle geometry, gas pressure, gas temperature, particle size, and particle density. Among those, gas pressure and temperature are process conditions that are easily adjustable on the cold spray applicator device 130. The effect of pressure and temperature on particle impact velocity may be estimated using continuum fluid dynamics (CFD) modeling or with laser particle velocimetry.

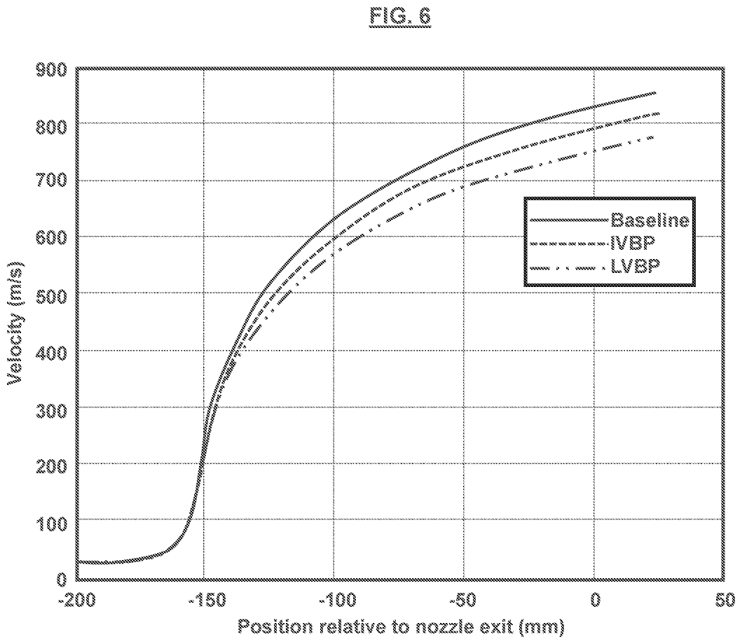

Predicting the relationship between the process conditions and particle impact velocity is helpful in identifying the suitable impact velocity or range of velocities for a particular cold spray build. The 1D isentropic equations of nozzle flow coupled with particle drag modeling are one very useful tool for predicting the relationship between process conditions and particle impact velocity. FIG. 6 shows a plot of impact velocity of a 30 micron particle under various processing conditions.

One aspect of selecting the suitable impact velocity is the ‘critical’ velocity. This is the velocity at which particles must be traveling in order to bond to the substrate 110. In theory, below this velocity particles of the cold spray material 115 would not adhere to the substrate 110. Typically, cold spray development is focused on getting impact velocities well above the critical velocity for the purpose of better adhesion and consolidation. However, and conversely, according to the embodiments herein, the objective is to achieve an impact velocity slightly above the critical velocity. The 1D isentropic model may be used to map the velocity of various process conditions with respect to the theoretical critical velocity of the cold spray material 115.

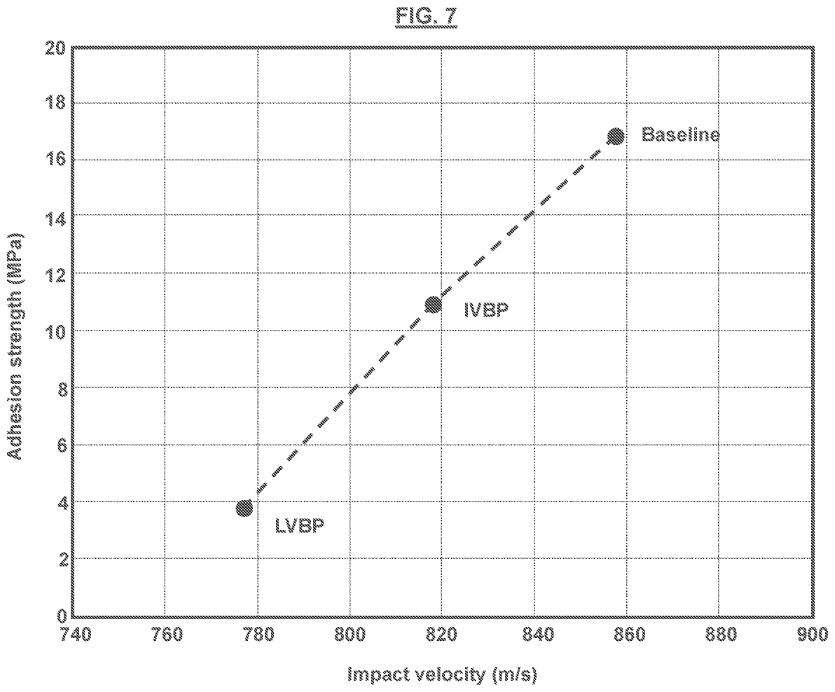

FIG. 7 shows the effect of impact velocity on adhesion strength. The plot shows three impact conditions, a low velocity bond pass (LVBP) with impact velocity just above the critical velocity, the baseline velocity which is the process that has been optimized for adhesion and material properties, and an intermediate velocity bond pass (IVBP) in which the velocity falls between the critical velocity and baseline velocity.

Several substrate materials and process conditions have been experimentally evaluated using a qualitative ‘tool release’ test. The test comprises spraying the cold spray material 115 to a representative thickness onto a small-area test coupon and attempting to induce release through a temperature swing. The temperature swing creates a higher strain mismatch between the cold spray material 115 and the substrate 110. In general, this test can have three different qualitative results: the deposit does not release, the deposit releases, or the deposit releases during cold spray. It is noted that this qualitative test may be carried out using alternative release strategies such as mechanical or vibrational agitation.

Experimentally, it was hypothesized that a LVBP (impact velocity just above critical velocity) would be ideal for release. Several substrate materials were evaluated using the qualitative tool release test and a LVBP. Across multiple toolings, the LVBP significantly reduces the adhesion strength. In some cases, the cold spray material 115 delaminates from the substrate 110 during the deposition process, which is an indicator of inadequate bonding. These observations suggest that an IVBP is helpful to utilize. This highlights one of the aspects of the embodiments herein that the cold spray bond layer must have sufficient bonding with the substrate 110 to complete deposition but must not have so much adhesion strength that the deposit release cannot be induced. As such, IVBPs with particle impact velocities approximately halfway between the LVBP particle velocities and the bulk deposition particle velocities have shown the greatest promise for tool release.

The IVBP has been experimentally evaluated using the tool-release test and has shown to have successful releases with several metallic substrates. The actual value for the target adhesion strength for inducing tool release is material and application-dependent. The value will be affected by several factors including part geometry, deposit thickness, material properties, and residual stresses present in the deposit. Therefore, the target adhesion strength may be determined by representative geometry release testing or by finite element analysis.

The embodiments herein provide the industry with two control mechanisms to achieve the desired adhesion strength. It is suggested that the effect of velocity on adhesion strength is much greater than hardness. This means that velocity may be used as a ‘rough’ control parameter to get the adhesion strength into the right range and then hardness may be used to ‘fine-tune’ to the final adhesion strength. Further, the variability of adhesion strength data due to lower velocity is greater than that of higher hardness. In other words, there is more noise associated with IVBPs. For this reason, it is preferred to lower the adhesion strength as much as can be performed by increasing tool hardness and then accomplishing the rest through velocity modulation. Increasing tool hardness also makes the tool more robust for repeated use, as the amount of plastic deformation that happens with each spraying is lower.

Another aspect of the embodiments herein is that the IVBP is a single layer process whereby the remainder of the thickness of the part is sprayed at the full optimized condition. The IVBP is optimized for inducing tool release but may not be preferred for material properties of the bulk deposit. On the other hand, the full condition is optimized for material properties and therefore has much greater inter-layer adhesion. Since the IVBP is only applied on the first layer, the resulting bulk deposit will have the material properties associated with the full spray condition. This process may be used to additively manufacture components. If the substrate mold is a negative of the component being additively manufactured with cold spray, then the deposit 105 can be built up to a near net shape component. Upon release of the deposit 105 from the substrate 110, the component will be a near net shape component of the desired part. Enabling use of hardface tooling, such as stainless steels, carburizable steels, gear steels, or other metallic materials coupled with tuned cold spray process parameters can enable reuse of the tooling and result in significant manufacturing throughput increases and reduction of tooling costs.

The use of a systematic approach through substrate property processing and cold spray process parameter selection for inferior bonding poses multiple advantages to conventional techniques used for release in prototype applications. The first and biggest advantage is that the tooling can be reused. Due to the classes of materials for substrates of interest being steels and stainless steels, the substrate 110 can maintain its geometry after deposit release for reuse. Furthermore, the use of an induced release process alleviates material property concerns associated with conventional prototype release techniques. For example, melting a zinc layer creates concern of diffusion of zinc into the cold spray deposit 105, which can degrade the part properties. Use of a sacrificial mold can create issues such as hydrogen embrittlement from off-gassing as a byproduct of the metal+acid reaction. Use of a sacrificial, dissolvable mold is also only applicable to a cold spray deposit material that is impervious to chemical attack while requiring use of a dissolvable tooling material. Accordingly, through the embodiments herein, it is not required that chemically resistant materials be used for cold spray additive manufacturing. In fact, the system 100 allows for a method 200 to be used that would work on materials that are susceptible to chemical attack as it relies on tuning of the substrate properties and cold spray bond layer conditions (particle impact velocity and temperature), rather than material chemical compatibilities.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

What is claimed is:

1. A method of controlling cold spray deposit adhesion for induced release of a deposit from a substrate, the method comprising:
tuning a material surface condition of a substrate used to support a build of a cold spray material to a level proportionate with deposition conditions of the cold spray material for adhesion to the substrate;
selecting an impact velocity for deposition of the cold spray material to be substantially equal to or greater than a critical velocity for adhesion of the cold spray material to the substrate;
depositing the cold spray material on the substrate to form a deposit; and
releasing the deposit from the substrate without permanently damaging the substrate to allow for reuse of the substrate for a subsequent cold spray deposition process.

2. The method of claim 1, comprising increasing the material surface condition of the substrate by carburization of the substrate.

3. The method of claim 1, comprising increasing the material surface condition of the substrate by nitriding the substrate.

4. The method of claim 1, comprising increasing the material surface condition of the substrate by heat treatment of the substrate.

5. The method of claim 1, comprising releasing the deposit from the substrate using thermal shock.

6. The method of claim 1, comprising releasing the deposit from the substrate using vibration.

7. The method of claim 1, comprising releasing the deposit from the substrate using a mechanical release mechanism.

8. The method of claim 1, wherein the impact velocity is selected to lower an adhesion strength of the cold spray material to the substrate.

9. The method of claim 1, comprising providing a material release layer on the substrate.

10. The method of claim 9, wherein the material release layer comprises a same material as the cold spray material.

11. A system for controlling cold spray deposit adhesion for induced release of a deposit from a substrate, the system comprising:
a first mechanism to tune a material surface condition of a substrate used to support a build of a cold spray material to a level proportionate with deposition conditions of the cold spray material for adhesion to the substrate;
a processor to select an impact velocity for deposition of the cold spray material to be substantially equal to or greater than a critical velocity for adhesion of the cold spray material to the substrate;
a cold spray applicator device to deposit the cold spray material on the substrate to form a deposit; and
a second mechanism to release the deposit from the substrate without permanently damaging the substrate to allow for reuse of the substrate for a subsequent cold spray deposition process.

12. The system of claim 11, wherein the material surface condition of the substrate is tuned by carburization of the substrate.

13. The system of claim 11, wherein the material surface condition of the substrate is tuned by nitriding the substrate.

14. The system of claim 11, wherein the material surface condition of the substrate is tuned by heat treatment of the substrate.

15. The system of claim 11, wherein the second mechanism is to release the deposit from the substrate using thermal shock.

16. The system of claim 11, wherein the second mechanism is to release the deposit from the substrate using vibration.

17. The system of claim 11, wherein the second mechanism is to release the deposit from the substrate using a mechanical release mechanism.

18. The system of claim 11, wherein the processor is to select the impact velocity to lower an adhesion strength of the cold spray material to the substrate.

19. The system of claim 11, comprising a third mechanism to apply a material release layer on the substrate.

20. The system of claim 19, wherein the material release layer comprises a same material as the cold spray material.
